(19) United States
(12) Patent Application Publication
(10) Pub. No.: US 2025/0166092 A1
(43) Pub. Date: May 22, 2025

(54) APPARATUS FOR GENERATING A DATABASE FOR CONTROLLING A WORKFLOW OF A PRODUCTION PROCESS

(71) Applicant: BASF SE, Ludwigshafen Am Rhein (DE)

(72) Inventors: Arunav MISHRA, Ludwigshafen (DE); Jürgen MÜLLER, Ludwigshafen (DE); Marco Oskar KENNEMA, Ludwigshafen (DE); Ulrich Thomas Michael RABENSTEIN, Ludwigshafen (DE); Lalita Shaki URIBE ORDONEZ, Ludwigshafen (DE)

(21) Appl. No.: 18/723,388

(22) PCT Filed: Dec. 20, 2022
(86) PCT No.: PCT/EP2022/087101

§ 371 Date: Jun. 21, 2024

(30) Foreign Application Priority Data
Dec. 21, 2021 (EP) 21216642.5

(51) Int. Cl. G06Q 50/04; G06F 16/901; G06N 20/00; G06Q 10/0631; G06Q 10/083

(52) U.S. Cl. CPC G06Q 50/04; G06F 16/9024; G06N 20/00; G06Q 10/06316; G06Q 10/0838

(57) ABSTRACT

The invention refers to an apparatus 110 for generating a database for controlling a workflow of a production process. A providing unit 111 provides a graph database template indicative of predefined product data, wherein product data refers to information related to a product. A providing unit 112 provides shipping data of the product, wherein the shipping data refers to data generated in relation to a logistic process. An extraction unit 113 extracts predefined product data for the product from the shipping data. A generation unit 114 generates a graph database for the product by utilizing the graph database template filled with the extracted predefined product data. A generation unit 115 generates, based on the graph database for the product, a control signal for affecting the workflow of the production process referring to the product.

### FIELD OF THE INVENTION

The invention relates to an apparatus, a method, a system comprising the apparatus and a computer program product for generating a database for controlling a workflow of a production process referring to a product. Further, the invention relates to a use of a generated database for controlling a workflow of a production process. Moreover, the invention relates to a training apparatus, a training method and a training computer program product for training a production data model that can be utilized by the apparatus.

### BACKGROUND OF THE INVENTION

Generally, today industrial production processes are often very complex and require a plurality of products and/or pre-products for producing in the end a final product. Additionally, modern industrial processes often rely on worldwide production such that for the production of a final product products and pre-products utilized for the production of the final product have to be shipped from different places to the final production place. Thus, during a production process being either a continuous or a batch production, the workflow of the production process, i.e. the different steps of the production, has to be planned and if necessary adapted accordingly. However, for this, often a huge amount of data has to be analysed, wherein it is often difficult to differentiate which data might have an influence on the workflow and necessitates a respective planning or adaptation of the workflow.

Moreover, also the reliability of the data can be difficult to assess, making it even more difficult to plan or adapt the workflow of the production process. Thus, it would be advantageous if data relevant for a controlling of a workflow of a production process would be identified faster and more reliable.

### SUMMARY OF THE INVENTION

It is an object of the present invention to provide an apparatus, a system comprising the apparatus, a method and a computer program product that allow for reliable and fast data processing for controlling a workflow of a production process. Moreover, it is further an object of the invention to provide a training apparatus, a training method and a computer program product that allow to provide a trained product data model that can be utilized in the apparatus, system, method and computer product for controlling the workflow of the production process.

In a first aspect of the present invention, an apparatus for generating a database for controlling a workflow of a production process referring to a product is presented, wherein the apparatus comprises a) a graph database template providing unit for providing a graph database template indicative of predefined product data for filling nodes and edges of a graph database, wherein product data refers to information related to the product and/or one or more pre-products utilized in the production process of the product, b) a shipping data providing unit for providing shipping data of the product and/or one or more pre-products utilized in the production process of the product, wherein the shipping data refers to data generated in relation to a logistic process concerning the product and/or the one or more pre-products, c) a predefined product data extraction unit for extracting predefined product data for the product and/or one or more pre-products from the shipping data, d) a graph database generation unit for generating a graph database for the product and/or the one or more pre-products by utilizing the graph database template filled with the extracted predefined product data, and e) a control signal generation unit for generating, based on the graph database for the product and/or the one or more pre-products, a control signal for affecting the workflow of the production process referring to the product.

Since product data that is based on shipping data is utilized for generating a graph database, data relevant for the workflow of the production process can be provided in a structured and reliable manner. Due to this provided structured and reliable graph database of the relevant data, searching and analysing becomes more effective and reliable such that the control signal for affecting the workflow of the production process allows for a more effective and reliable controlling of the workflow of the production process. Moreover, utilizing shipping data and generating control signals based on a graph database for a product that is generated based on the shipping data, allows to structure and analyse the huge amount of logistic data provided by the shipping data of any given product such that a fast reaction to any changes, shortages or differences in the logistics of the product planning becomes possible. Thus, the product planning becomes more flexible and accurate if further the shipping data is taken into account. Moreover, a user provided with the technical task of optimizing a production planning utilizing the above described invention can perform this task faster and more efficient, due to the structured and reliable manner in which the data is provided by the graph database.

The apparatus is adapted to generate a database for controlling a workflow of a production process referring to a product. Generally, the apparatus can be realized in form of any hardware and/or software that provides the functions of the units of the apparatus. Moreover, the apparatus can be realized as or as part of a computing device or a network of computing devices, like a cloud or a server network. The production process can refer to any industrial production process of a final product or intermediate product that is utilized in further production processes. In particular, the production process refers to a product, wherein the product can be the final product or, more preferably, the product to which the production process refers is a product that has to be utilized during the production process of a final or intermediate product. Preferably, the product and/or the one or more pre-products refer to a chemical product produced in a chemical production process, wherein the control signal is adapted to affect the flow of a chemical production process. A workflow of a production process generally refers to a scheduling and controlling of steps necessary for the production of the final or intermediate product. In particular, the scheduling and controlling comprises a direct or indirect controlling of manufacturing facilities, i.e. of the process machinery in manufacturing facilities, for performing the production process. For example, the controlling and scheduling can refer to determining when and how the specific valves, heaters, stirring machineries, compressors, etc. are to be utilized during the production process.

The graph database template providing unit is adapted to provide a graph database template. In particular, the graph database template providing unit can refer to or can be communicatively coupled to a storage unit on which the graph database template is already stored. Moreover, in this case also more than one graph database template can be stored on the storage, for instance, graph databases providing different predefined product data or relating to different structuring of the predefined product data. The graph database template providing unit can then be adapted to select a respective graph database template for providing the same. However, the graph database template providing unit can also refer to a receiving unit for receiving a graph database template, for instance, from a storage or from a user input.

The graph database template is indicative of predefined product data for filling nodes and edges of a graph database. Generally, a graph database is a database that uses graph structures with nodes, edges and properties to represent and store data, wherein data items, here predefined product data items, are stored related to the collection of nodes and edges of the graph database. In this context, edges of the graph database represent a relationship between nodes connected by the respective edges. Nodes represent items of interest for which respective relations are tracked by the graph database. Moreover, properties refer to information related to a respective note item. Thus, a graph database allows not only to store data items but also to store relationships between the data items and properties of the data items such that the data is linked together in a context sensitive way such that respective complex data structures can be visualized and queried.

In this general context, the graph database template refers to any kind of structure that indicates the data items, here the predefined product data items, that are to be utilized for generating the graph database, in particular, for filling the nodes and edges of the graph database. For example, the graph database template can refer to a list of the predefined product data items that are to be utilized for filling nodes and edges. However, the graph database can also refer to a two- or more-dimensional table structure in which predefined product data items are defined with a specific two- or more-dimensional structure. For example, in such two- or more-dimensional structures related predefined product data items can be provided in the same rows or columns of the table.

The product data refers to information related to the product and/or one or more pre-products utilized in the production process of a product. Thus, product data can be any information that is related to the product and/or the one or more pre-products, for instance, can refer to where a product is produced, when it is shipped, how it is shipped, which company is producing the product, a quality or technical characteristic of the product, etc. The predefined product data in this context refers to a selection of items of the overall product data that are to be utilized in the graph database template. Thus, the predefined product data can be regarded as a subset, i.e. a sublist of items, of the product data. In particular, the predefined product data is predefined such that the relevant product data for a predetermined function of the generated graph database can be provided. Moreover, the graph database template can be adapted to already indicate the structure of the graph database, for instance, by indicating already whether a predefined product data item refers to a node or an edge or by indicating a connection between different predefined product data items. For example, a predefined product data item in the template can indicate that a shipment is associated with a predetermined product data item relating to a port which is again related via a “located in” relationship with a predefined production data item relating to a country of the port.

The shipping data providing unit is adapted to provide shipping data of the product and/or one or more pre-products utilized in the production process of the product. In particular, also the shipping data providing unit can refer to or can be communicatively coupled to a storage unit on which the shipping data is already stored and then adapted for providing the already stored shipping data. However, also the shipping data providing unit can refer to a receiving unit for receiving the shipping data, for instance, from a storage, a sensor unit or a user input, and for providing the same. The shipping data refers to data that is generated in relation to a logistics process concerning the product and/or one or more pre-products. Preferably, the shipping data refers to publicly available data. For example, the shipping data can refer to tracking data generated when tracking the shipping process of a product and/or one or more pre-products, can refer to customs data generated during a transfer of the product and/or the one or more pre-products through customs, can refer to transfer data or security data generated for a safe transfer of the product and/or one or more pre-products, etc. Preferably, the shipping data comprises logistic sensor data provided by measurements of sensors during the logistic process concerning the product and/or the one or more pre-products. In particular, during shipping the product is provided with one or more identifications that will be measured by sensors, for instance, scanned, during different phases and stations of the shipping process. For example, a container comprising one or more products will be provided on the outside with an identification indicator indicating not only the content but also different data related to the content of the respective container that is scanned during the shipping process a plurality of times. The advantage of utilizing logistic sensor data as shipping data is that the logistic sensor data is very reliable and accurate and less prone to errors compared, for instance, with handwritten customs data.

The predefined product data extraction unit is adapted to extract predefined product data for the product and/or one or more pre-products from the shipping data. Generally, the extracting of predefined product data is defined by extracting respective values for the predefined product data items from the shipping data. Accordingly, the extraction comprises identifying in the shipping data a data item or information as defined by the template as predefined product data item and to reading out a respective value of the identified data item as value of the respective predefined product data item. In this context, the term “value” does not necessarily refer to a numeric value but generally refers to the content of a data item and thus can also refer to a word, sentence, image or graphic representation. For example, if the predefined product data item refers to a production place of the product, the value can refer to the name of a city or country in which the production place is located. If in an embodiment the shipping data comprises at least partly a free text section, the predefined product data extraction unit is adapted to utilize natural language processing to extract predefined product data from the free text section. Generally, known natural language processing methods can be utilized for extracting content from such text sections in the shipping data. Preferably, the natural language processing includes an automatic parsing of respective free text sections and utilizing learned or predefined patterns to identify relevant data items, for instance, product names and descriptions. For example, a product name and code can be provided in the text together with some parameters like a molecule size of the product in a specific predefined pattern. These different data items can then be identified and utilized as product data items. Moreover, such information can also be combined to generate or recognize a product identification.

The graph database generation unit is adapted to generate a graph database for the product and/or the one or more pre-products by utilizing the graph database template filled with the extracted predefined product data. Generally, the filling of the graph database template with the extracted predefined product data refers to inserting or otherwise associating the determined values of the extracted predefined product data items to the predefined places provided by the graph database template. The generating of the graph database from the filled graph database template can then be performed by utilizing predetermined rules for the graph database generation. For example, the graph database template can be structured such that it is already indicative on which extracted predefined product data item refers to a node and which extracted predefined product data item refers to an edge or property. Thus, the graph database can then be generated utilizing the predetermined rules that indicate where in the filled graph database template structure the extracted predefined product data item for a respective node or edge of the graph database can be found.

The control signal generation unit is then adapted to generate based on the graph database for the product and/or the one or more pre-products a control signal for affecting the workflow of the production process referring to the product. In particular, the control signal generation unit can be adapted to query the graph database and to generate the control signal based on the result of the respective query. In this context, the control signal generation unit can be adapted to automatically query the graph database, for instance, based on a predetermined query workflow that indicates when a specific query should be provided to a graph database, for example, in relation to a specific production workflow phase of a product, or can be communicatively coupled with a user interface that allows a user to provide queries to the graph database. For example, the result of such a query can allow to determine when or where a specific product and/or pre-product will arrive and thus can be inserted into the workflow of the production process. The control signals can refer to any control signals that affect the workflow of the respective production process referring to the product. For example, the control signals can refer to a direct control of the workflow of the production process or to an indirect control of the workflow of the production process. In case of a direct control, the control signals can directly control, for example, a part of a production plant executing the workflow of the production process. However, an indirect control of the control signals can lead, for instance, to a change in the scheduling of the workflow of the production process without directly controlling the production process.

In an embodiment, the apparatus further comprises a searching unit adapted to search the graph database based on a received query, wherein the search unit is adapted to translate the received query into a graph pattern query and to search the graph database for graph patterns corresponding to the graph pattern query, wherein the control signal generation unit is adapted to generate the control signal based on the result of the search. The received query can refer to a predetermined query, for instance, a query stored on a storage unit that can be a part of a workflow of queries that are automatically provided to the graph database. However, the received query can also refer to a query received from a user via a user interface. The received query can generally already be in form of a graph pattern query, wherein in this case the translation can be omitted or refers to a simple providing of the received query for searching the graph database. However, the query can also be provided in another form, for instance, as a question in a known language. In this case, the translation can refer to applying natural language processing to identify the content of the question and to generate based on the content of the question a graph pattern query. For example, the relations between different subjects of the question can refer to edges in the graph pattern query and the respective subjects can refer to nodes in the graph pattern query, wherein one node or edge is unknown, i.e. refers to the node or edge that should be determined by the query. Based on the graph pattern query, known searching algorithms for searching graph databases can be utilized for determining the result of the query, for instance, the answer to the question.

In an embodiment, the apparatus further comprises a missing data determination unit adapted to determine missing product data by comparing the predefined product data with the extracted predefined product data and to predict the identified missing product data based on the extracted predefined product data. In many application cases, not all predefined product data is available in the shipping data. For example, a predefined product data item might refer to a starting location of a shipment of a product, however, this starting location might for some reason not be mentioned in the available shipping data. By comparing the predefined product data with the extracted predefined product data, for example, item-wise, the missing data determination unit is adapted to determine for such cases which of the predefined product data items are missing. In particular, the missing data determination unit can utilize a list of the predefined product data items that are defined by the graph database template and determine whether after the extraction step a value for predefined product data items on the list is still missing. Such a missing value then indicates that this product data item has not been extracted during the extraction step. The missing data determination unit is then adapted to predict the identified missing product data based on the extracted predefined product data. For example, the missing data determination unit can be adapted to utilize predetermined rules for identifying the missing product data based on the already extracted predefined product data. For example, the rules can be quite simple like indicating that if a starting location of a product shipment is not provided, the country of the port from which the product was shipped should be set as starting location or, if sensor data from a specific part of the shipping route is not provided, the sensor data from a previous or later shipping part of the shipping process should be utilized. However, also more complex rules for a specific predefined product data item can be applied and provided, for instance, as part of a lookup table containing the rules that can then be applied by the missing data determination unit depending on the determined missing product data item.

In a preferred embodiment, the missing data determination unit is adapted to utilize, for predicting the identified missing data based on the extracted predefined product data, a trained machine learning based product data model that has been trained to predict missing product data based on already extracted predefined product data. The machine learning based product data model can be based on any known machine learning algorithm, for instance, can be based on a neural network, a random forest algorithm, a regression algorithm, etc. Generally, the machine learning based product data model can be a supervised machine learning models or unsupervised machine learning model. In the preferred case of a supervised machine learning model it is preferred that the machine learning based product data model refers to a feed-forward neural network with a classification layer. For an unsupervised machine learning model it is preferred that the machine learning based product data model refers to a rule based model that defines a specific textual construct.

The machine learning based product data model can be trained on historical product data of similar but also of different products, wherein respective parts of the historical product data can then be marked as missing and the trained machine learning based production data model can learn to predict this missing product data based on the provided product data.

In a preferred embodiment, the missing product data model is trained to further utilize as input already existing graph databases of products and/or one or more pre-products for predicting the missing product data. Utilizing already existing graph databases provides even more data to the missing product data model that can be utilized to derive the missing product data. For example, if a product is shipped by the same company as another product that has already an existing graph database and is sent to the same location, a missing starting location of the shipment for the first product is derivable from the graph database of the other product. In this embodiment, the missing product data model is also trained respectively based on historical existing graph databases to derive missing data.

In an embodiment, the apparatus further comprises a quality determination unit adapted to determine a quality of a generated graph database, wherein the control signal generation unit is adapted to further generate the control signals based on the determined quality of the graph database. A quality of the graph database can be determined in a plurality of ways. In particular, the quality determination unit can be adapted to determine the quality of a generated graph database based on the amount of missing product data that can be predicted as described above. For example, the more product data items are missing in the shipping data, the lower the quality of the generated graph database can be determined, due to the general uncertainty in the predicted product data. Moreover, the quality determination unit can also be adapted to utilize a predetermined list indicating the reliability of different product data sources. For example, shipping data coming from sensor measurements can be regarded as comprising a high reliability and thus a high quality, whereas handwritten shipment forms can be regarded as being of lower reliability and thus of lower quality. The quality determination unit can then be adapted to utilize such a list for weighting the product data for determining a quality of the generated graph database. Moreover, the quality determination unit can be adapted to determine a quality of each product data item in the generated graph database and determine the quality of the generated graph database as a combination of the qualities of all product data qualities, for example, an average, lowest quality, highest quality, etc. In a preferred embodiment, the quality determination unit is adapted to determine if a value for a predefined product data item is extracted by the extraction unit from more than one data source, for instance, from sensor data and shipment forms provided in the shipping data. The quality determination unit can then be adapted to determine the quality of product data that can be found in more than one data source as higher than product data that can be found in only one data source.

In an embodiment, the apparatus comprises further an additional data proving unit adapted to provide additional data related to the product and/or the one or more pre-products, wherein the predefined product data extraction unit is adapted to further extract predefined product data from the additional data for filling the graph database template. The additional data can refer to any data that is related to the product and/or the one or more pre-products and is, for instance, not already provided by the shipping data. For example, production process data of the product can be provided by the additional data like a recipe for producing the product. This additional data allows for a further increase and detailing of the generated graph database.

In an embodiment, the apparatus further comprises an overall graph database generation unit adapted to generate based on a plurality of product and/or one or more pre-product graph databases an overall graph database by connecting product and/or pre-product graph databases of the plurality of graph databases when it is determined that product data of a node and/or edge of respective graph databases are related. Connecting a plurality of graph databases that comprise related nodes and/or edges into an overall graph database allows for an even wider structuring, sorting and querying of the provided data. Nodes and/or edges of respective graph databases can be regarded as being related if they comprise the same content or if they comprise a relationship that can be specified by an edge. The respective graph databases can then be connected over the same node content or over a new edge referring to the respective relation between the nodes to form the overall graph database.

In a further aspect of the invention a system for providing a control signal for controlling a workflow of a production process referring to a product is presented, wherein the system comprises a) an apparatus as described above, b) a storage unit for storing graph databases for products and/or one or more pre-products generated by the apparatus, c) an interface unit adapted to allow a user to interact with graph databases as stored in the storage unit and/or with the apparatus.

In a further aspect of the invention a training apparatus for training a product data model is presented, wherein the training apparatus comprises a) a training data providing unit for providing training data, wherein the training data comprises predefined product data for a plurality of products and/or one or more pre-products, respectively, b) a trainable product data model providing unit for providing a trainable machine learning based product data model, c) a training unit for training the trainable product data model utilizing the provided training data until the trained product data model is adapted to predict one or more predefined product data missing in a predefined product data set of a product and/or pre-product based on the predefined product data present in the respective predefined product data set.

In a further aspect of the invention a method for generating a database for controlling a workflow of a production process referring to a product is presented, wherein the method comprises a) providing a graph database template indicative of predefined product data for filling nodes and edges of a graph database, wherein product data refers to information related to the product and/or one or more pre-products utilized in the production process of the product, b) providing shipping data of the product and/or one or more pre-products utilized in the production process of the product, wherein the shipping data refers to data generated in relation to a logistic process concerning the product and/or the one or more pre-products, c) extracting predefined product data for the product and/or one or more pre-products from the shipping data, d) generating a graph database for the product and/or the one or more pre-products by utilizing the graph database template filled with the extracted predefined product data, and e) generating, based on the graph database for the product and/or the one or more pre-products, a control signal for affecting the workflow of the production process. Generally, the method refers to a computer-implemented method.

In a further aspect of the invention a training method for training a product data model is presented, wherein the training method comprises a) providing training data, wherein the training data comprises predefined product data for a plurality of products and/or pre-products, respectively, b) providing a trainable machine learning based product data model, c) training the trainable product data model utilizing the provided training data until the trained product data model is adapted to predict data missing in a predefined product data set of a product and/or pre-product based on the predefined product data present in the respective predefined product data set. Generally, the method refers to a computer-implemented method.

In a further aspect of the invention a computer program product for providing a control signal for controlling a workflow of a production process referring to a product is presented, wherein the computer program product comprises program code means for causing the apparatus as described above to execute the method as described above.

In a further aspect of the invention a computer program product for training a product data model is presented, wherein the computer program product comprises program code means for causing the apparatus as described above to execute the method as described above.

In a further aspect of the invention a use of a graph database generated by the apparatus as described above to control a chemical production process of a chemical product is presented.

It shall be understood that the apparatus as described above, the system comprising the apparatus as described above, the method as described above and the computer program product as described above have similar and/or identical preferred embodiments, in particular, as defined in the dependent claims. Moreover, also the training apparatus as described above, the training method as described above, and the training computer program product as described above have similar and/or identical preferred embodiments, in particular, as defined in the dependent claims.

It shall be understood that a preferred embodiment of the present invention can also be any combination of the dependent claims or above embodiments with the respective independent claim.

These and other aspects of the present invention will be apparent from and elucidated with reference to the embodiments described hereinafter.

### BRIEF DESCRIPTION OF THE DRAWINGS

In the following drawings:

FIG. 1 shows schematically and exemplarily an embodiment of a system for providing control signals for controlling a workflow of a production process referring to a product,

FIG. 2 shows schematically and exemplarily an embodiment of an apparatus for training a production data model,

FIG. 3 shows schematically and exemplarily a flowchart of a method for generating a control signal for controlling a workflow of a production process of a product, and

FIG. 4 shows schematically and exemplarily a flowchart of a method for training a product data model.

### DETAILED DESCRIPTION OF EMBODIMENTS

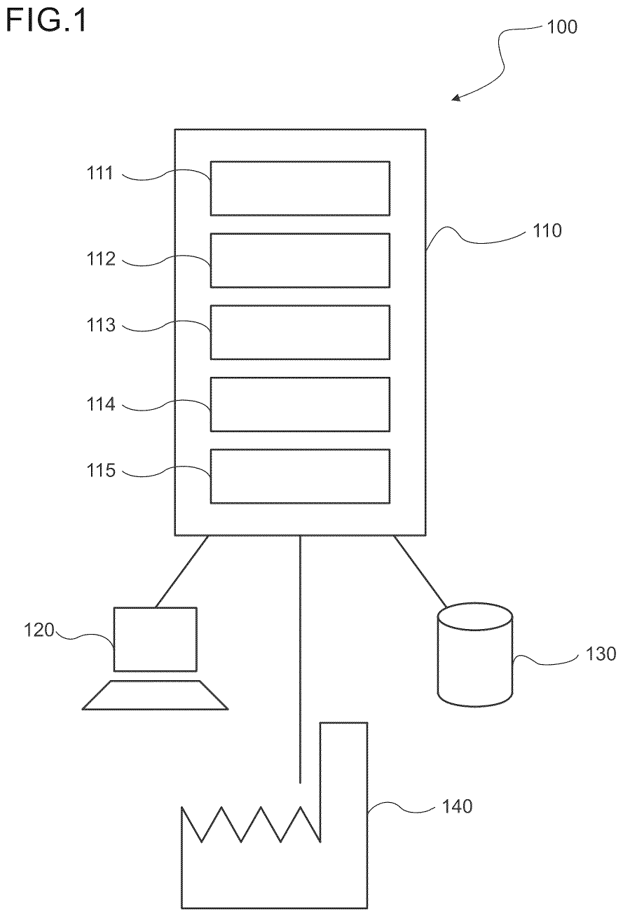

FIG. 1 shows schematically and exemplarily a system 100 for providing a control signal for controlling a workflow of a production process referring to a product. The system 100 comprises an apparatus 110 for generating a database for controlling a workflow of a production process referring to a product, a storage unit 130 for storing graph databases generated by the apparatus 110, and an interface unit 120 adapted to allow a user to interact with the graph databases stored on the storage unit and/or with the apparatus 110. Moreover, the system 100, in particular, the apparatus 110, is communicatively coupled to respective controlling systems of a production plant 140 performing the production process referring to a product.

Generally, the production process can refer to any product producible by an industrial plant. Moreover, the workflow of a production process performed by an industrial plant refers to all steps that are necessary for producing a respective final product in the production plant 140. Thus, the workflow of the production process can refer to the steps of localizing and transporting respective pre-products from other production plants to the respective production plant 140. However, the workflow can also refer to the steps performed by the production plant 140 itself, in particular, to the monitoring and controlling of the steps of the production process. Generally, the production process refers to a product if it either produces the respective product, for instance, as final product or as one or more intermediate products of the production process, or if it utilizes the product in any other way during the production process of another product.

The apparatus 110 comprises a graph database template providing unit 111, a shipping data providing unit 112, a predefined product data extraction unit 113, a graph database generation unit 114 and a control signal generation unit 115. The graph database template providing unit 111 can, in particular, be realized as a computational unit that is communicatively coupled to or refers to a storage unit on which one or more graph database templates are already stored. Preferably, a plurality of graph database templates are provided, for instance, for different products and/or pre-products or for different predefined product data items. In such a case, the graph database template providing unit 111 can be adapted to act as a selecting unit for selecting a suitable graph database template from the plurality of graph database templates. For example, the graph database template providing unit 111 can then be adapted to utilize the user interface 120 to interact with the user for selecting a respective graph database template. However, the graph database template providing unit 111 can also be adapted to automatically select a suitable graph database template, for instance, based on predefined rules or based on a simple input of the user.

The graph database template is then indicative of predefined product data for filling nodes and edges of a graph database. For example, the graph database template can have the form of a table or a list, wherein the list or table indicates at which space a value of a predefined product data item should be filled. A respective space of the list or table can then be directly associated with a node or edge of the later generated graph database. Generally, product data refers to all information related to the product and/or one or more pre-products that are utilized in the production process of the product. Thus, the product data can generally refer to information like recipe data that is indicative of a recipe of the product and/or pre-product, operation data indicative of operation parameters for producing the product and/or pre-product, sensor data generated in connection with the product and/or pre-product, general product information like a manufacturer, a batch amount, shipment information, identification numbers, etc.

The shipping data providing unit 112 is adapted to provide shipping data of the product and/or the one or more pre-products utilized in the production process of the product. Also for the shipping data providing unit 112 it is preferred that it is realized as computing unit communicatively coupled to or referring to a storage unit 130 on which the shipping data is already stored. However, the shipping data providing unit 112 can also be adapted as a receiving unit for receiving the shipping data, for instance, from other data sources like the internet, a cloud network, a scanner, etc. The shipping data refers to data and information generated in relation to a logistic process concerning the product and/or the one or more pre-products. For example, products and/or pre-products are often not produced in the direct environment of the production plant 140 in which they are later to be utilized such that they have to be shipped from the manufacturing site to the industrial plant 140. During this logistic process, a plurality of data is generated, for example, when identifiers of the product like RFID chips, barcodes, etc. are scanned by a scanner, i.e. sensor, at a plurality of locations on the respective shipping way to the location of the production plant 140. However, during the logistic process also other data like, for instance, customs forms, security manuals, transport manuals, etc. are generated. Thus, a plurality of information can be provided by the shipping data referring not only to simple locations of the product and/or pre-product but also to information like quality, amount, security, state, characteristics, etc. of the product. Therefore, this information provided by the shipping data can be regarded as relevant for the planning and performing of a production process workflow.

The predefined product data extraction unit 113 is adapted to extract the predefined product data for the product and/or one or more pre-products from the shipping data. In particular, the predefined product data extraction unit 113 can be adapted to utilize the graph database template to determine which predefined product data should be extracted from the shipping data and can then be adapted to extract the predefined product data by extracting the respective values of the predefined product data from the shipping data. Preferably, the extraction unit 113 is adapted to utilize natural language processing for extracting the predefined product data if the shipping data comprises at least partly free text sections. Generally, known natural language processing methods can be utilized for extracting content from such text sections in the shipping data. Preferably, the natural language processing includes an automatic parsing of respective free text sections and utilizing learned or predefined patterns to identify relevant data items, for instance, product names and descriptions.

The graph database generation unit 114 is then adapted to generate a graph database for the product and/or the one or more pre-products by utilizing the graph database template filled with the extracted predefined product data. For example, in the filled graph database template the values extracted for the predefined product data items are associated with the respective space in the graph database template. The graph database generation unit 114 can then utilize predefined rules for generating the graph database. For instance, respective spaces in the graph database template can be defined to be associated with nodes and/or edges of the generated graph database. However, the rules can also be more complex for generating the graph database. For example, the rules can indicate that one or more of the predefined product data values should be combined before being associated with a node or edge of the graph database, wherein the combination can refer to an averaging, a subtracting, an adding or any other mathematic or logical function. Moreover, the rules can also comprise if/then constructions that indicate, for instance, that if a certain predefined product data item fulfils a predefined condition, like lying above or below a predefined threshold, a respective predefined consequence is utilized for the generation of the graph database, for instance, a node of the graph database is filled with a predefined value.

The control signal generation unit 115 can then be adapted to generate a control signal for affecting the workflow of the production process performed by the production plant 140. The control signal is generally generated based on the graph database for the product and/or the one or more pre-products. For example, the control signal can be generated based on an automatic analysis of the graph database with respect to one or more predefined queries performed by the graph database generation unit 114. For example, a query can refer to a respective product quality or a predicted time of arrival, wherein based on these predetermined queries the graph database generation unit 114 can be adapted to query the graph database and generate the control signals based on the results of the query. For example, if the result of the query refers to the product comprising a low quality, the control signal generated by the control signal generation unit 115 can refer to adding production steps to the workflow of the production process that increase the quality of the product, for instance, cleaning steps or other preparing steps. Generally, the control signal generation unit 115 can utilized predetermined rules or lookup tables for determining which control signals are to be provided based on a result of a respective query. Moreover, the control signal generation unit 115 can also be adapted to learn respective control signals from an interaction with a user. For example, if based on a query result a user initiates a specific controlling by providing respective control signals, the control signal generation unit 115 can be adapted to store the respective control signals in association with the respective result and to utilize the stored control signals, if again the result is found, for instance, in another graph database of another product. The respective determined or amended workflow of the production process can then be implemented into the production plant 140.

Further, the apparatus 110 can be adapted to store the generated graph database on the graph database storage unit 130. Moreover, the apparatus 110 can optionally further comprise a searching unit that allows for a search of respective graph databases, for instance, graph databases stored in the storage unit 130, based on a received query. A respective query can be received, for instance, via the interface unit 120 that can be adapted to allow a user to input a query. The searching unit can be adapted to translate a received query into a graph pattern query, for instance, using natural language processing to determine in the question semantics that indicate edges and nodes of a graph pattern. Generally, known methods for translating, for instance, a natural language query into a graph pattern query can be utilized, as, for instance, described in more detail in the articles “Answering natural language questions by subgraph matching over knowledge graphs.” by S. Hu, et al., IEEE TRANSACTIONS ON KNOWLEDGE AND DATA ENGINEERING (2017), pages 824 to 837 and “Querying knowledge graphs in natural language.” by S. Liang et al., Journal of Big Data (2021), pages 1 to 23. The searching unit can then be adapted to search the graph database for respective graph patterns corresponding to the graph pattern query. The found result of the query can then be provided via the interface unit 120 to a user or can be utilized by the control signal generation unit 115 for generating the control signal. Thus, in this example, the control signal can be generated by the control signal generation unit 115 in an interactive process with the user providing a respective query for querying graph database.

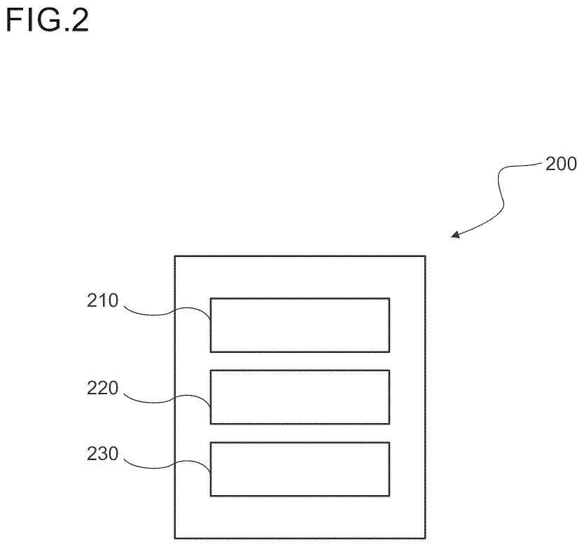

In a further preferred embodiment, the apparatus 110 can comprise a missing data determination unit that is adapted to determine missing product data in the extracted predefined product data. In particular, the shipping data might not contain all predefined product data, i.e. might be missing values of one or more predefined product data items. The missing data determination unit can be adapted to determine such missing product data by comparing the predefined product data with the extracted predefined product data, in particular, by determining for which predefined product data items no value has been extracted. The missing data determination unit can then further be adapted to predict the identified missing product data based on the already extracted predefined product data. For the prediction predefined rules can be utilized, for instance, depending on which product data is missing. However, it is preferred that the missing data determination unit is adapted to utilize a trained machine learning based product data model that has been trained to predict the missing product data based on the already extracted predefined product data. The trained machine learning based product data model can be trained, for example, by an apparatus 200 as shown in FIG. 2.

The apparatus 200 shown in FIG. 2 is adapted to train a product data model to predict respective missing product data. In particular, the training apparatus 200 comprises a training data providing unit 210 for providing training data, a trainable product data model providing unit 220 for providing a trainable machine learning based product data model and a training unit 230 performing the training of the trainable product data model. The training data providing unit 210 can refer to a storage unit on which the training data is already stored or can be communicatively coupled with such a storage unit. Preferably, the training data providing unit 210 is further communicatively coupled to the storage unit 130 storing one or more already generated graph databases. The training data provided by the training data providing unit 210 comprises predefined product data for a plurality of products and/or one or more pre-products, respectively. The predefined product data for a product can be regarded as a predetermined product data sets comprising more than one predefined product data item. For example, product data extracted for previous products and/or pre-products for which a graph database has been generated can be utilized. In particular, the training data providing unit 210 can be adapted to utilize the already generated graph databases on storage unit 130 for determining respective product data for a plurality of products and/or pre-products.

The trainable product data model providing unit 220 is then adapted to provide a trainable machine learning based product data model. Such a trainable product data model can be based on any known machine learning algorithm, like a neural network, a random forest, a Bayesian classifier, etc. Preferably, the trainable product data model refers to a supervised machine learning model, in particular, to a feed-forward neural network with a classification layer. However, also an unsupervised machine learning model can be utilized, in particular, a rule based model that defines a specific textual construct. The respective trainable machine learning based product data models can be stored on a storage unit that can be accessed by the trainable product data model providing unit 220 for providing a respective trainable machine learning based product data model. The training unit 230 is then adapted for training the trainable product data model. In particular, the provided training data is utilized for the training of the trainable product data model. The training can be performed utilizing any known training methods for machine learning based algorithms, wherein the training is performed until the trained product data model is adapted to predict one or more predefined product data items missing in a predefined product data of a product and/or pre-product based on the predefined product data present in the respective predefined product data set. The such trained product data model can then be utilized by the missing data determination unit of the apparatus 110 for predicting the identified missing product data.

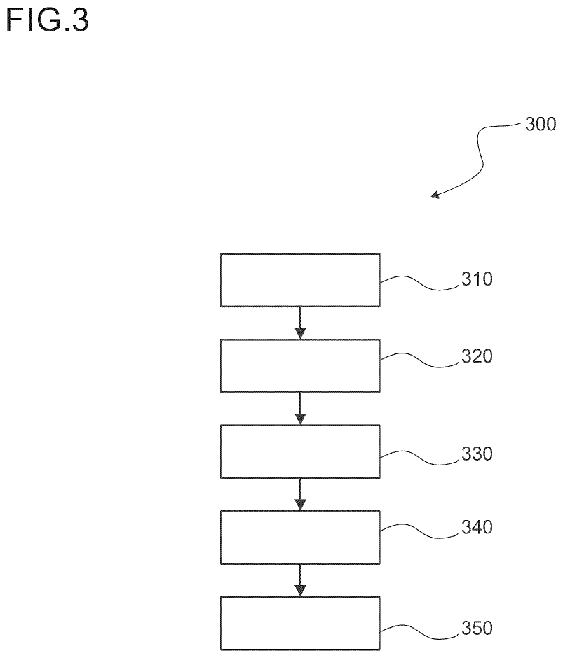

FIG. 3 shows schematically and exemplarily a flowchart of a method 300 for generating a database for controlling a workflow of a production process referring to a product. Generally, the method 300 can be performed, for instance, by the apparatus 110 as described in detail with respect to FIG. 1. In particular, the steps of the method 300 can be performed by one or more of the units of the apparatus 110 as already described above. The method 300 comprises a step 310 of providing a graph database template indicative of predefined product data for filling nodes and edges of the graph database. Further, the method 300 comprises a step 320 of providing shipping data of the product and/or one or more pre-products utilized in the production process of the product. In a further step 330, the predefined product data is extracted for the product and/or one or more pre-products from the shipping data. In step 340 a graph database is then generated for the product and/or the one or more pre-products by utilizing the graph database template filled with the extracted predefined product data. In a last step 350, a control signal is then generated for affecting the workflow of the production process, wherein the control signal is generated based on the graph database for the product and/or the one or more pre-products. Moreover, also further steps can be provided by the method 300, like steps of searching the graph database or determining and predicting missing product data, wherein the steps can be performed in accordance with the principles already described above.

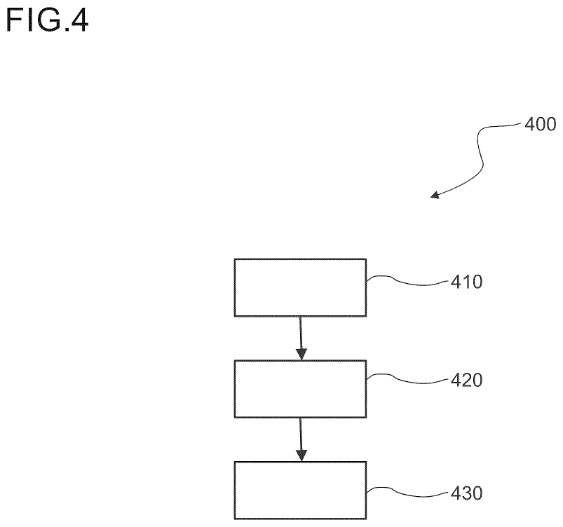

FIG. 4 shows schematically and exemplarily a training method 400 for training a product data model, wherein the training method 400 can be performed, for instance, by the apparatus 200 described with respect to FIG. 2. Generally, the steps of the method 400 can refer to the functions provided by one or more of the units of the apparatus 200 as already described above. In particular, the method 400 comprises a first step 410 of providing training data comprising predefined product data for a plurality of products and/or pre-products, respectively. In step 420, further a trainable machine learning based product data model is provided. Moreover, in the last step 430, the trainable product data model is trained utilizing the provided training data. In particular, the trainable product data model is trained until the trained product data model is adapted to predict data missing in a predefined product data set of a product and/or pre-product based on the predefined product data present in the respective predefined product data set.

One of the fundamental advantages of the invention as exemplarily described above is to be able to combine publicly available product data released by customs of multiple countries in an automated manner. The respective data can always be kept up to date and, using techniques from natural language processing, combined, i.e. queried, for instance, to identify if products or pre-products being received for the production process and those that are described by the trade data are identical. This goal is achieved by providing an accurate data integration by using graph databases for structuring and storing the huge amount of available product data such that respective queries can be utilized for automatic feature identification in the product data.

In the following further principles of the invention with respect to the generation of the graph database are described. Generally, for generating the graph database, shipping data referring to shipment and/or customs information can be gathered and provided, for example, by the shipping data providing unit. This shipping data, preferably, comprises sensor data. For example, containers are often tracked electronically by tags located on the container and then scanned at various customs locations such as ports. This scanned shipping data is generally publicly available and this information can be gathered from respective databases in an already pre-structured form.

In some cases, however, shipping data is not complete, i.e. does not comprise values for all predefined product data items of a graph database template, and as such it is preferred that a data preparation is performed, for instance, to predict values for respectively missing product data. Preferably, this data preparation is supported by machine learning. Moreover, sometimes information about the products that are shipped is only available in a free text section of the shipping data. For this, preferably text recognition is applied and further a natural languish processing algorithm is utilized to extract product information, i.e. product data, from that text. The extracted product data can then be utilized for generating the graph database. Preferably, the generated graph database can then be evaluated, i.e. a quality of the generated graph database can be determined. For example, for each extracted product data value, or more generally for each product data source, a quality can be determined and the respective extracted product data can be ranked accordingly. Moreover, the quality can also be determined in an interactive manner, in which a user is asked to manually inspect at least part of the extracted product data and to provide feedback with respect to the quality. This quality feedback by the user can then be utilized to determine a quality of the generated graph database. Moreover, the quality determined for product data or for the graph database can be provided to a user to allow a user to assess a relevance of the respective product data and/or graph database.

Preferably, the product data provided in form of the graph database is further harmonized by a unified code, for example, by utilizing an HS Code, which refers to an internationally used code for products. This code is already widely used in customs and tracking such that providing the product data in such a format allows for an easy transfer of the data to different platforms. Furthermore, these codes are often utilized by other databases and therefore allow easy enrichment of the graph database structure by gathering additional data from other data sources. One additional data source can refer to information related to further aspects of the product and can comprise, for example, a synthesis specification, or a parts list for a product.

The graph database can be generated and implemented with respect to different use cases. For example, the graph database can be utilized for generating control signals for affecting a scheduling production of a material in an industrial plant. In such an application, the control signal generation unit can be provided with production process information relating to a production process of a product, e.g. in form of a recipe or synthesis specification. The control signal generation unit can then be adapted to derive ingredients, i.e. pre-products, from the provided production process information. Based in the derived ingredients the control signal generation unit can then be adapted to query respectively generated graph databases of the ingredients with respect to current geolocation of the ingredients. Moreover, also other information, like the kind of shipping, can be queried from the graph database of the ingredients. Based on this queried information the control signal generation unit can be adapted to estimate a time of arrival (ETA) for the ingredients, for example, based on known interpolation rules and can then generate control signals for scheduling a production of an industrial plant based on the estimated ETAs.

Other variations to the disclosed embodiments can be understood and effected by those skilled in the art in practicing the claimed invention, from a study of the drawings, the disclosure, and the appended claims.

In the claims, the word “comprising” does not exclude other elements or steps, and the indefinite article “a” or “an” does not exclude a plurality.

A single unit or device may fulfill the functions of several items recited in the claims. The mere fact that certain measures are recited in mutually different dependent claims does not indicate that a combination of these measures cannot be used to advantage.

Procedures like the providing of the graph database template and the shipping data, the extracting of the predefined product data, the generating of the graph database and the generating of control signals, etc., performed by one or several units or devices can be performed by any other number of units or devices. These procedures can be implemented as program code means of a computer program and/or as dedicated hardware.

A computer program product may be stored/distributed on a suitable medium, such as an optical storage medium or a solid-state medium, supplied together with or as part of other hardware, but may also be distributed in other forms, such as via the Internet or other wired or wireless telecommunication systems.

Any units described herein may be processing units that are part of a computing system. Processing units may include a general-purpose processor and may also include a field programmable gate array (FPGA), an application specific integrated circuit (ASIC), or any other specialized circuit. Any memory may be a physical system memory, which may be volatile, non-volatile, or some combination of the two. The term “memory” may include any computer-readable storage media such as a non-volatile mass storage. If the computing system is distributed, the processing and/or memory capability may be distributed as well. The computing system may include multiple structures as “executable components”. The term “executable component” is a structure well understood in the field of computing as being a structure that can be software, hardware, or a combination thereof. For instance, when implemented in software, one of ordinary skill in the art would understand that the structure of an executable component may include software objects, routines, methods, and so forth, that may be executed on the computing system. This may include both an executable component in the heap of a computing system, or on computer-readable storage media. The structure of the executable component may exist on a computer-readable medium such that, when interpreted by one or more processors of a computing system, e.g., by a processor thread, the computing system is caused to perform a function. Such structure may be computer readable directly by the processors, for instance, as is the case if the executable component were binary, or it may be structured to be interpretable and/or compiled, for instance, whether in a single stage or in multiple stages, so as to generate such binary that is directly interpretable by the processors. In other instances, structures may be hard coded or hard wired logic gates, that are implemented exclusively or near-exclusively in hardware, such as within a field programmable gate array (FPGA), an application specific integrated circuit (ASIC), or any other specialized circuit. Accordingly, the term “executable component” is a term for a structure that is well understood by those of ordinary skill in the art of computing, whether implemented in software, hardware, or a combination. Any embodiments herein are described with reference to acts that are performed by one or more processing units of the computing system. If such acts are implemented in software, one or more processors direct the operation of the computing system in response to having executed computer-executable instructions that constitute an executable component. Computing system may also contain communication channels that allow the computing system to communicate with other computing systems over, for example, network A “network” is defined as one or more data links that enable the transport of electronic data between computing systems and/or modules and/or other electronic devices. When information is transferred or provided over a network or another communications connection, for example, either hardwired, wireless, or a combination of hardwired or wireless, to a computing system, the computing system property views the connection as a transmission medium. Transmission media can include a network and/or data links which can be used to carry desired program code means in the form of computer-executable instructions or data structures and which can be accessed by a general-purpose or special-purpose computing system or combinations. While not all computing systems require a user interface, in some embodiments, the computing system includes a user interface system for use in interfacing with a user. User interfaces act as input or output mechanism to users for instance via displays.

Those skilled in the art will appreciate that the invention may be practiced in network computing environments with many types of computing system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, datacenters, wearables, such as glasses, and the like. The invention may also be practiced in distributed system environments where local and remote computing system, which are linked, for example, either by hardwired data links, wireless data links, or by a combination of hardwired and wireless data links, through a network, both perform tasks. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources, e.g., networks, servers, storage, applications, and services. The definition of “cloud computing” is not limited to any of the other numerous advantages that can be obtained from such a model when deployed. The computing systems of the figures include various components or functional blocks that may implement the various embodiments disclosed herein as explained. The various components or functional blocks may be implemented on a local computing system or may be implemented on a distributed computing system that includes elements resident in the cloud or that implement aspects of cloud computing. The various components or functional blocks may be implemented as software, hardware, or a combination of software and hardware. The computing systems shown in the figures may include more or less than the components illustrated in the figures and some of the components may be combined as circumstances warrant.

Any reference signs in the claims should not be construed as limiting the scope.

The invention refers to an apparatus for generating a database for controlling a workflow of a production process. A providing unit provides a graph database template indicative of predefined product data, wherein product data refers to information related to a product. A providing unit provides shipping data of the product, wherein the shipping data refers to data generated in relation to a logistic process. An extraction unit extracts predefined product data for the product from the shipping data. A generation unit generates a graph database for the product by utilizing the graph database template filled with the extracted predefined product data. A generation unit generates, based on the graph database for the product, a control signal for affecting the workflow of the production process referring to the product.

1. An apparatus for generating a database for controlling a workflow of a production process referring to a product, wherein the apparatus comprises:
a graph database template providing unit for providing a graph database template indicative of predefined product data for filling nodes and edges of a graph database, wherein product data refers to information related to the product and/or one or more pre-products utilized in the production process of the product,
a shipping data providing unit for providing shipping data of the product and/or one or more pre-products utilized in the production process of the product, wherein the shipping data refers to data generated in relation to a logistic process concerning the product and/or the one or more pre-products,
a predefined product data extraction unit for extracting predefined product data for the product and/or one or more pre-products from the shipping data,
a graph database generation unit for generating a graph database for the product and/or the one or more pre-products by utilizing the graph database template filled with the extracted predefined product data, and
a control signal generation unit for generating, based on the graph database for the product and/or the one or more pre-products, a control signal for affecting the workflow of the production process referring to the product.

2. The apparatus according to claim 1, wherein the product and/or the one or more pre-products refer to a chemical product produced in a chemical production process, wherein the control signal is adapted to affect the flow of a chemical production process.

3. The apparatus according to claim 1, wherein the apparatus further comprises a searching unit adapted to search the graph database based on a received query, wherein the search unit is adapted to translate the received query into a graph pattern query and to search the graph database for graph patterns corresponding to the graph pattern query, wherein the control signal generation unit is adapted to generate the control signal based on the result of the search.

4. The apparatus according to claim 1, wherein the apparatus further comprises a missing data determination unit adapted to determine missing product data by comparing the predefined product data with the extracted predefined product data and to predict the identified missing product data based on the extracted predefined product data.

5. The apparatus according to claim 4, wherein the missing data determination unit is adapted to utilize, for predicting the identified missing data based on the extracted predefined product data, a trained machine learning based product data model that has been trained to predict missing product data based on already extracted predefined product data.

6. The apparatus according to claim 5, wherein the missing product data model is trained to further utilize as input already existing graph databases of products and/or one or more pre-products for predicting the missing product data.

7. The apparatus according to claim 1, wherein the shipping data comprises at least partly a free text section, wherein the predefined product data extraction unit is adapted to utilize natural language processing to extract predefined product data from the free text section.

8. The apparatus according to claim 1, wherein the apparatus further comprises a quality determination unit adapted to determine a quality of a generated graph database, wherein the control signal generation unit is adapted to further generate the control signals based on the determined quality of the graph database.

9. The apparatus according to claim 1, wherein the apparatus comprises further an additional data proving unit adapted to provide additional data related to the product and/or the one or more pre-products, wherein the predefined product data extraction unit is adapted to further extract predefined product data from the additional data for filling the graph database template.

10. The apparatus according to claim 1, further comprising an overall graph database generation unit adapted to generate based on a plurality of product and/or one or more pre-products graph databases an overall graph database by connecting product and/or pre-product graph databases of the plurality of graph databases when it is determined that product data of a node and/or edge of respective graph databases are related.

11. The apparatus according to claim 1, wherein the shipping data comprises logistic sensor data provided by measurements of sensors during the logistic process concerning the product and/or the one or more pre-products.

12. A system for providing a control signal for controlling a workflow of a production process referring to a product, wherein the system comprises:
an apparatus according to claim 1,
a storage unit for storing graph databases for products and/or one or more pre-products generated by the apparatus, and
an interface unit adapted to allow a user to interact with graph databases as stored in the storage unit and/or with the apparatus.

13. A training apparatus for training a product data model, wherein the training apparatus comprises:
a training data providing unit for providing training data, wherein the training data comprises predefined product data for a plurality of products and/or one or more pre-products, respectively,
a trainable product data model providing unit for providing a trainable machine learning based product data model, and
a training unit for training the trainable product data model utilizing the provided training data until the trained product data model is adapted to predict one or more predefined product data missing in a predefined product data set of a product and/or pre-product based on the predefined product data present in the respective predefined product data set.

14. A method for generating a database for controlling a workflow of a production process referring to a product, wherein the method comprises:
providing a graph database template indicative of predefined product data for filling nodes and edges of a graph database, wherein product data refers to information related to the product and/or one or more pre-products utilized in the production process of the product,
providing shipping data of the product and/or one or more pre-products utilized in the production process of the product, wherein the shipping data refers to data generated in relation to a logistic process concerning the product and/or the one or more pre-products,
extracting predefined product data for the product and/or one or more pre-products from the shipping data,
generating a graph database for the product and/or the one or more pre-products by utilizing the graph database template filled with the extracted predefined product data, and
generating, based on the graph database for the product and/or the one or more pre-products, a control signal for affecting the workflow of the production process.

15. A training method for training a product data model, wherein the training method comprises:
providing training data, wherein the training data comprises predefined product data for a plurality of products and/or pre-products, respectively,
providing a trainable machine learning based product data model, and
training the trainable product data model utilizing the provided training data until the trained product data model is adapted to predict data missing in a predefined product data set of a product and/or pre-product based on the predefined product data present in the respective predefined product data set.

16. A computer program product for providing a control signal for controlling a workflow of a production process referring to a product, wherein the computer program product comprises program code means for causing the apparatus of claim 1 to provide a control signal for controlling a workflow of a production process referring to a product.

17. A computer program product for training a product data model, wherein the computer program product comprises program code means for causing the apparatus of claim 11 to train a product data model.

18. A method to control a chemical production process of a chemical product comprising using a graph database generated by the apparatus according to claim 1.
